(19) United States
(12) Patent Application Publication
(10) Pub. No.: US 2020/0338875 A1
(43) Pub. Date: Oct. 29, 2020

(54) ADJUSTABLE LIGHT-TRANSMITTING HIGH-TEMPERATURE-RESISTANT ULTRATHIN FILM

(71) Applicant: WING TAK LEE SILICONE RUBBER TECHNOLOGY (SHENZHEN) CO., LTD, Shenzhen (CN)

(72) Inventor: Tak Nam Liu, Shenzhen (CN)

(21) Appl. No.: 16/505,697

(22) Filed: Jul. 8, 2019

(30) Foreign Application Priority Data
Apr. 26, 2019 (CN) 201910346282.3

(51) Int. Cl. B32B 27/40; C08L 75/04; C08L 29/04; C08K 3/04; C08K 3/08; G02B 1/14; B32B 7/023; B32B 7/025

(52) U.S. Cl. CPC B32B 27/40; C08L 75/04; C08L 29/04; C08K 3/042; C08K 3/08; G02B 1/14; B32B 2307/732; B32B 7/025; C08K 2003/085; C08K 2003/0856; B32B 2305/55; B32B 2307/202; B32B 2307/412; B32B 7/023

(57) ABSTRACT

The present application provides an adjustable light-transmitting high-temperature-resistant ultrathin film, which comprises a waterborne polyurethane composite film and an intelligent film; wherein the intelligent film comprises a front conducting layer, a rear conducting layer and a middle component; the front conducting layer is disposed on the front surface of the middle component, the outer surface of the front conducting layer is attached to the polyurethane film, and the rear conducting layer is disposed on the rear surface of the middle component; the protecting film is adhered and fixed to the outer side surface of the front conducting layer, the outer side surface of the rear conducting layer is adhered to the rear surface of glass; the middle component is a component having molecules ordering arrangement in an electronic field and having molecules disordering arrangement without the electronic field.

### CROSS-REFERENCE TO RELATED APPLICATION

The present application is based upon and claims priority to Chinese patent application No. 201910346282.3, filed on Apr. 26, 2019, the entire content of which is incorporated herein by reference.

### TECHNICAL FIELD

The disclosure relates to the field of electronic accessories, and particularly relates to a novel adjustable light-transmitting high-temperature-resistant ultrathin film.

### BACKGROUND

A protecting film can be divided into a digital product protecting film, an automobile protecting film, a domestic protecting film, a food preservation protecting film and the like according to use. With the popularization of digital products such as a mobile phone in China, the protecting film has gradually become a general term of screen protecting films, and has various functions in the field of screen protecting films. Its material has been developed for more than 5 years from the earliest PP material to a popular AR material nowadays, and gradually is accepted by vast mobile phone user groups.

The current protecting film has a large thickness which is generally more than 0.15 mm. The large thickness influences the experience of a user.

### SUMMARY

An embodiment of the present application provides a novel adjustable light-transmitting high-temperature-resistant ultrathin film, which can reduce the thickness of the protecting film so that the thickness is up to 0.06 mm, thereby improving the experience of a user.

The first embodiment of the present application provides a novel adjustable light-transmitting high-temperature-resistant ultrathin film, wherein the novel adjustable light-transmitting high-temperature-resistant ultrathin film includes a waterborne polyurethane composite film and an intelligent film;

wherein, the intelligent film includes a front conducting layer, a rear conducting layer and a middle component; the front conducting layer is disposed on the front surface of the middle component, the outer surface of the front conducting layer is attached to the polyurethane film, and the rear conducting layer is disposed on the rear surface of the middle component; the protecting film is adhered and fixed to the outer side surface of the front conducting layer, the outer side surface of the rear conducting layer is adhered to the rear surface of glass; the middle component is a component having molecules ordering arrangement in an electronic field and having molecules disordering arrangement without the electronic field.

Preferably, the waterborne polyurethane composite film comprises the following compositions by weight percents:

1-3% of poval;

30-50% of polyurethane;

0.1-0.5% of graphene;

1-1.5% of metal powder;

0.1-0.2% of a curing agent;

1-2% of an organic toner;

0.2% of a coupling agent; and

the remaining is deionized water.

The percentages of the above compositions are 100%.

Preferably, the metal powder is mixed metal powder of iron powder and copper powder.

Preferably, the middle component is composed of a mixed material of a liquid crystal body and a high polymer material filling material.

Implementation of the embodiment of the present application has the following beneficial effects:

It can be seen that the present application provides a novel adjustable light-transmitting ultrathin film which adopts a structure comprising a waterborne polyurethane composite film and an intelligent film. For the intelligent film, it has an adjustable light-transmitting characteristic after being electrified, that is, it can transmit lights after being electrified and cannot transmit lights after being not electrified, and its thickness is thin, and can be less than 0.05 mm subsequently; for the waterborne polyurethane composite film, it has the appearance and property of an elastomer after being dried and cured. A transparent or semi-transparent film having good flexibility can be obtained. Furthermore, the waterborne polyurethane film resists wear and heat, and the thickness of the waterborne polyurethane composite film can be less than 0.01 mm, thus the thickness of the ultrathin film obtained by adopting the above technology can be less than 0.06 mm, so the ultrathin film obtained by adopting the above technology has the characteristics of ultra-thinness, wear resistance and adjustable light transmission performance.

### BRIEF DESCRIPTION OF THE DRAWINGS

For more clearly describing the technical solution in the embodiment of the present application, drawings used in the description of the embodiment will be simply described below, apparently, the drawings in the following description are some embodiments of the present application, and those of ordinary skill in the art can also obtain other drawings according to these drawings without creative efforts.

FIG. 1 is a structural diagram of a novel adjustable light-transmitting high-temperature-resistant ultrathin film according to an embodiment of the present application.

FIG. 2 is an electrified light diagram of an intelligent film according to the embodiment of the present application.

FIG. 3 is a non-electrified light diagram of an intelligent film according to the embodiment of the present application.

### DESCRIPTION OF THE EMBODIMENTS

The technical solution in an embodiment of the present application will be clearly and completely described in combination with drawings in the embodiment of the present application, apparently, the described embodiments in the following description are parts of embodiments of the present application, but not all the embodiments. Based on the embodiment of the present application, other embodiments obtained by those of ordinary skill in the art without creative efforts all fall within the protective scope of the present application.

Terms “first”, “second”, “third” and “fourth” or the like used in the specification and claims as well as the drawings of the present application are intended to distinguish different objects, but not describe a specific sequence. Furthermore, terms “including” and “having” as well as any transformations thereof are intended to cover non-exclusive comprising. For example, processes, methods, systems, products or devices comprising a series of steps or units are not limited to steps or units that have been listed, and optionally include steps or units that have not been listed, or optionally also include other steps or units that are inherent to these processes, methods, products or devices.

“Embodiment” mentioned herein means that, specific features, structures or properties described in combination with the embodiment can be contained in at least one embodiment of the present application. Embodiments where this phase occurs at various locations of the specification do not necessarily refer to the same embodiments, and are not independent or alternative embodiments mutually exclusive one another. Those skilled in the art will explicitly and implicitly understand that the embodiments described herein can be combined with other embodiments.

Referring to FIG. 1, FIG. 1 is a novel adjustable light-transmitting system, including a novel adjustable light-transmitting ultrathin film. The ultrathin film includes a waterborne polyurethane composite film 10 and an intelligent film 20. The system includes a control circuit 30, wherein, the control circuit is used for controlling the intelligent film to be in a transparent state or in a non-transparent state, the intelligent film is used for converting the transparent state or the non-transparent state according to a signal of the control circuit;

the intelligent film includes a front conducting layer, a rear conducting layer and a middle component; the front conducting layer is disposed on the front surface of the middle component; the outer surface of the front conducting layer is attached to the polyurethane film, and the rear conducting layer is disposed on the rear surface of the middle component; the protecting film is adhered and fixed to the outer side surface of the front conducting layer, the outer side surface of the rear conducting layer is adhered to the rear surface of glass; the middle component is a component having molecules ordering arrangement in an electronic field and having molecules disordering arrangement without the electronic field.

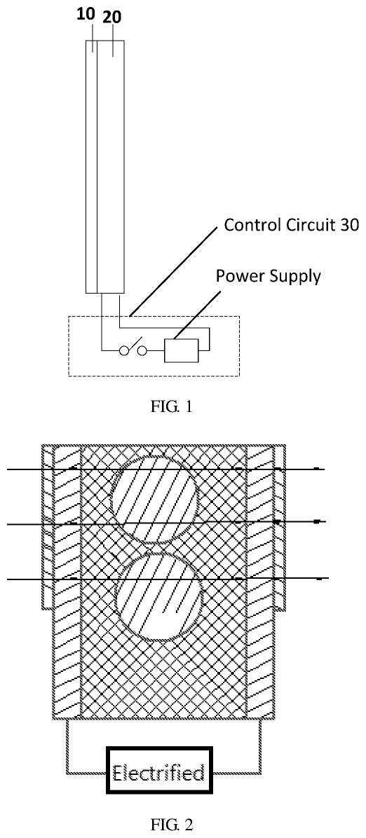

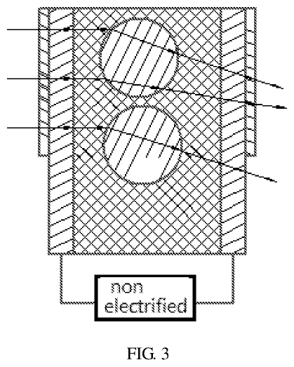

The ultrathin film provided by the technology of the present application adopts a structure comprising the waterborne polyurethane composite film and the intelligent film. For the intelligent film, it has an adjustable light-transmitting characteristic after being electrified, that is, it can transmit lights after being electrified (as shown in FIG. 2) and cannot transmit lights after being not electrified (as shown in FIG. 3), and its thickness is thin, and can be less than 0.05 mm subsequently; for the waterborne polyurethane composite film, it has an appearance and property of an elastomer after being dried and cured. A transparent or semi-transparent film having good flexibility can be obtained. Furthermore, the waterborne polyurethane film resists wear and heat, and the thickness of the waterborne polyurethane composite film can be less than 0.01 mm, thus the thickness of the ultrathin film obtained by adopting the above technology can be less than 0.06 mm, so the ultrathin film obtained by adopting the above technology has the characteristics of ultra-thinness, wear resistance and adjustable light transmission performance.

Preferably, the middle component is specifically composed of a mixed material of a liquid crystal body and a high polymer material filling material.

Preferably, the above control circuit may include a power source and a film switch. The positive and negative electrodes of the power source are electrically connected with the front conducting layer and the rear conducting layer through the film switch.

Preferably, the mass percentage of the above waterborne polyurethane composite film is as follows:

1-3% of poval;

30-50% of polyurethane;

0.1-0.5% of graphene;

1-1.5% of metal powder;

0.1-0.2% of a curing agent;

1-2% of an organic toner;

0.2% of a coupling agent; and

the remaining is deionized water.

The percentages of the above compositions are 100%.

A method for preparing the above polyurethane composite film can include:

A. adding poval into a proper amount of deionized water, then adding graphene, metal powder and a coupling agent, sufficiently mixing, subsequently, heating to 100° C., and curing for 45 minutes to obtain a semi-finished product;

B. uniformly mixing the semi-finished product with polyurethane, a curing agent and an organic toner in deionized water under the condition of ultrasonic wave at 100° C. to obtain a mixed latex, and standing the mixed latex for ripening; and

C. immersing a mould of a composite film into the ripened mixed latex, taking out, drying to form the composite film on the mould.

In is noted that the organic toner is added here, the composite film can be adjusted to have other semi-transparent colors after addition of the organic toner, in such a way, personality can be increased. Addition of metal powder and graphene is to improve the conductivity of the composite film, which facilitates binding to the front conducting layer.

The metal powder can be mixed metal powder of iron powder and copper powder (mass percentage can be determined by a preparation party).

It is noted that for the sake of a brief description, the foregoing embodiments of various methods are described as a series of action combinations, but those skilled in the art should be aware that the present application is not limited by the described action order, as some steps may be performed in other orders or simultaneously according to the present application. Secondly, those skilled in the art should also be aware that the embodiments described in the specification are all optional embodiments and the actions and modules involved are not necessarily required for the present application.

In the above embodiments, the description of each embodiment has its own emphasis, and parts that are not detailed in one embodiment may refer to the relevant descriptions of other embodiments.

In several embodiments provided by the present application, it is understood that the disclosed device can be achieved in other manners. For example, the above described device embodiments are only exemplary, for example, division of the units is only division of logical functions, other division manners may be present when in practical achievement, for example, multiple units or components may be combined or integrated to another system, or some features may be ignored, or not implemented. From another aspect, the displayed or discussed mutual coupling or direct coupling or communication connection may be indirect coupling or communication connection through some interfaces, devices or units, and may be in electrical or other forms.

The units described as separated components may be or may also not be physically separated. The components displayed as display units may be or may also be not physical units, namely, may be located at one place, or may also be distributed to multiple network units. Part or all of the units here may be selected according to a practical need to achieve the purposes of the solutions of the embodiments of the present application.

In addition, various functional units in various embodiments of the present application can be integrated in one processing unit, or various units can be individually physically present, or two or more units can be integrated in one unit. The above integrated units can be achieved in a hardware form, or in a software program module.

When the integrated unit is achieved in a form of the software program module and sold or used as an independent product, it can be memorized in one computer readable memory. Based on this understanding, technical solutions of the present application substantively, or a part thereof making a contribution to the prior art, or all of or parts of this technical solution, may be reflected in the form of a software product stored in a memorizer, including several instructions to enable a computer equipment (e.g., personal computer, server, network facility, etc.) to execute all of or parts of the steps in the methods of respective embodiments of the present application. The memory mentioned above includes: a U disk, a read-only memory (ROM), a random access memory (RAM), a mobile hard disk, a disk or CD, and other media that can store program code.

It can be understood by those skilled in the art that all or parts of the steps in the various methods of the above embodiments can be accomplished by directing the relevant hardware through a program that can be stored in a computer readable memory, which may include: a flash disk, a read-only memory (ROM) and a random access memory (RAM), a disk or CD, etc.

The embodiments of the present application are described in detail above. The principle and implementation of the present application are described with specific examples herein. The description of the above embodiments is only used for helping to understand the method and core ideas of the present application. At the same time, for those of ordinary skill in the art, specific implementations and application scopes can all be varied according to the thought of the present application. In summary, the contents of this specification should not be construed as limiting the present application.

What is claimed is:

1. An adjustable light-transmitting high-temperature-resistant ultrathin film, comprising a waterborne polyurethane composite film and an intelligent film;
wherein the intelligent film comprises a front conducting layer, a rear conducting layer and a middle component; the front conducting layer is disposed on the front surface of the middle component, the outer surface of the front conducting layer is attached to the polyurethane film, and the rear conducting layer is disposed on the rear surface of the middle component; the protecting film is adhered and fixed to the outer side surface of the front conducting layer, the outer side surface of the rear conducting layer is adhered to the rear surface of glass; the middle component is a component having molecules ordering arrangement in an electronic field and having molecules disordering arrangement without the electronic field.

2. The adjustable light-transmitting high-temperature-resistant ultrathin film of claim 1, wherein the mass percentage of the waterborne polyurethane composite film is as follows:
1-3% of poval;
30-50% of polyurethane;
0.1-0.5% of graphene;
1-1.5% of metal powder;
0.1-0.2% of a curing agent;
1-2% of an organic toner;
0.2% of a coupling agent; and
the remaining is deionized water,
the total percentage is 100%.

3. The adjustable light-transmitting high-temperature-resistant ultrathin film of claim 2, wherein the metal powder is mixed metal powder of iron powder and copper powder.

4. The adjustable light-transmitting high-temperature-resistant ultrathin film of claim 1, wherein the middle component is composed of a mixed material of a liquid crystal body and a high polymer material filling material.
